(19) United States
(12) Patent Application Publication
(10) Pub. No.: US 2025/0224955 A1
(43) Pub. Date: Jul. 10, 2025

(54) HOT UPGRADE METHOD AND APPARATUS FOR KERNEL MODULE, DEVICE, AND STORAGE MEDIUM

(71) Applicants: Beijing Volcano Engine Technology Co., Ltd., Beijing (CN); Lemon Inc., Grand Cayman (KY)

(72) Inventors: Zhening ZHANG, Los Angeles, CA (US); Fan YANG, Beijing (CN); Zijing HUANG, Beijing (CN); Shilin MO, Beijing (CN); Yang ZHANG, Beijing (CN)

(21) Appl. No.: 18/909,459

(22) Filed: Oct. 8, 2024

(30) Foreign Application Priority Data
Jan. 4, 2024 (CN) 202410012395.0

(51) Int. Cl. G06F 8/656

(52) U.S. Cl. CPC G06F 8/656

(57) ABSTRACT

A hot upgrade method for a kernel module includes: when a hot upgrade request for a kernel module is triggered, calling a hot upgrade thread in a newly inserted hot upgrade updating module, and obtaining, by using the hot upgrade thread, a read-write lock that is pre-inserted into a basic module in the kernel module, to block first interface address information of a hot-upgradable module in the kernel module from being called, where the hot upgrade updating module includes second interface address information corresponding to each of a plurality of function call interfaces; and calling each function to be hot-upgraded by using the hot upgrade thread, and replacing, for a function call interface corresponding to each function, the first interface address information corresponding to the function call interface with the second interface address information by using the hot upgrade thread, to complete hot upgrade for the kernel module.

### CROSS-REFERENCE TO RELATED APPLICATION

This application claims priority to Chinese Patent Application No. 202410012395.0, filed on Jan. 4, 2024, which is hereby incorporated by reference in its entirety.

### TECHNICAL FIELD

Embodiments of the present disclosure relate to the field of computer technologies, and in particular, to a hot upgrade method and apparatus for a kernel module, a device, and a storage medium.

### BACKGROUND

With development of computer technologies, a kernel module is relied on by more and more service components and is used for data transmission. Currently, in a maintenance process of the kernel module, the kernel module needs to be upgraded to improve stability of the kernel module.

In the related art, steps of upgrading the kernel module are as follows: First, disable and deactivate a service component that relies on the kernel module; and then, upgrade the kernel module. For example, the kernel module may be a kernel transmission module, and the kernel transmission module is configured to carry transmission of key data or a control signal of the service component.

However, the inventors have found that the prior art has at least the following technical problems: in upgrading a kernel module, a service component that relies on the kernel module needs to be disabled and deactivated, and hence when there are a large number of service components that rely on the kernel module, a large amount of time would be spent on disabling and deactivating the service components, and therefore efficiency of the foregoing upgrade method is low.

### SUMMARY

Embodiments of the present disclosure provide a hot upgrade method and apparatus for a kernel module, a device, and a storage medium, which can improve efficiency of kernel module upgrading.

According to a first aspect, an embodiment of the present disclosure provides a hot upgrade method for a kernel module, including:
when a hot upgrade request for the kernel module is triggered, calling a hot upgrade thread in a newly inserted hot upgrade updating module, and obtaining, by using the hot upgrade thread, a read-write lock that is pre-inserted into a basic module in the kernel module, to block first interface address information of a hot-upgradable module in the kernel module from being called, where the hot upgrade updating module includes second interface address information corresponding to each of a plurality of function call interfaces; and where the kernel module includes the basic module and the hot-upgradable module, the hot-upgradable module is a part in the kernel module that supports a hot upgrade operation, and the basic module is configured to support hot upgrade of the hot-upgradable module; and
calling each function to be hot-upgraded by using the hot upgrade thread, and replacing, for a function call interface corresponding to each function, the first interface address information corresponding to the function call interface with the second interface address information by using the hot upgrade thread, to complete hot upgrade for the kernel module.

According to a second aspect, an embodiment of the present disclosure provides a hot upgrade apparatus for a kernel module, including:
a blocking module, configured to: when a hot upgrade request for the kernel module is triggered, call a hot upgrade thread in a newly inserted hot upgrade updating module, and obtain, by using the hot upgrade thread, a read-write lock that is pre-inserted into a basic module in the kernel module, to block first interface address information of a hot-upgradable module in the kernel module from being called, where the hot upgrade updating module includes second interface address information corresponding to each of a plurality of function call interfaces; and where the kernel module includes the basic module and the hot-upgradable module, the hot-upgradable module is a part in the kernel module that supports a hot upgrade operation, and the basic module is configured to support hot upgrade of the hot-upgradable module; and
an upgrading module, configured to: call each function to be hot-upgraded by using the hot upgrade thread, and replace, for a function call interface corresponding to each function, the first interface address information corresponding to the function call interface with the second interface address information by using the hot upgrade thread, to complete hot upgrade for the kernel module.

According to a third aspect, an embodiment of the present disclosure provides an electronic device, including:
a processor, and a memory that is communicatively connected to the processor,
where the memory stores a computer-executable instruction; and
the processor executes the computer-executable instruction stored in the memory, to implement the hot upgrade method for the kernel module according to the first aspect.

According to a fourth aspect, an embodiment of the present disclosure provides a computer-readable storage medium in which a computer-executable instruction is stored, where when a processor executes the computer-executable instruction, the hot upgrade method for the kernel module according to the first aspect is implemented.

According to a fifth aspect, an embodiment of the present disclosure provides a computer program product, including a computer program, where when the computer program is executed by a processor, the hot upgrade method for the kernel module according to the first aspect is implemented.

The present embodiments provide a hot upgrade method and apparatus for a kernel module, a device, and a storage medium. The method includes: when a hot upgrade request for the kernel module is triggered, calling a hot upgrade thread in a newly inserted hot upgrade updating module, and obtaining, by using the hot upgrade thread, a read-write lock that is pre-inserted into a basic module in the kernel module, to block first interface address information of a hot-upgradable module in the kernel module from being called, where the hot upgrade updating module includes second interface address information corresponding to each of a plurality of function call interfaces; and where the basic module is configured to support hot upgrade of the hot-upgradable module; and calling each function to be hot-upgraded by using the hot upgrade thread, and replacing, for a function call interface corresponding to each function, the first interface address information corresponding to the function call interface with the second interface address information by using the hot upgrade thread, to complete hot upgrade for the kernel module. In the embodiments of the present application, because the read-write lock is pre-inserted into the basic module, blocking of the first interface address information in the hot-upgradable module from being called is achieved, and an upgrade environment is provided for the hot-upgradable module. In addition, the first interface address information corresponding to the function call interface can be replaced with the second interface address information by using the hot upgrade thread, to implement hot upgrade. In an upgrade process, a related service component does not need to be deactivated, thereby improving upgrade efficiency. In addition, because the service component is in an online state in the upgrade process, related software can be upgraded/replaced without user perception, thereby improving user experience.

### BRIEF DESCRIPTION OF DRAWINGS

In order to more clearly describe the technical solutions in the embodiments of the present disclosure or in the prior art, a brief introduction will be made hereunder to the accompanying drawings used for description of the embodiments or the prior art. Apparently, the accompanying drawings in the following description show some embodiments of the present disclosure, and a person of ordinary skill in the art may still derive other drawings from these accompanying drawings without creative efforts.

FIG. 1 is a schematic diagram of an application scenario of a hot upgrade method for a kernel module according to an embodiment of the present disclosure.

FIG. 2 is a flowchart of a hot upgrade method for a kernel module according to an embodiment of the present disclosure.

FIG. 3 is a flowchart of another hot upgrade method for a kernel module according to an embodiment of the present disclosure.

FIG. 4 is a schematic diagram of hot upgrade of a kernel module according to an embodiment of the present disclosure.

FIG. 5 is a flowchart of another hot upgrade method for a kernel module according to an embodiment of the present disclosure.

FIG. 6 is a block diagram of a structure of a hot upgrade apparatus for a kernel module according to an embodiment of the present disclosure.

FIG. 7 is a schematic diagram of a hardware structure of an electronic device according to an embodiment of the present disclosure.

### DESCRIPTION OF EMBODIMENTS

To make the objectives, technical solutions, and advantages of the embodiments of the present disclosure clearer, description will be made hereunder clearly and comprehensively to the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should be noted that user information (including but not limited to user device information and user personal information) and data (including but not limited to data for analysis, data for storage, and data for presentation) involved in the present application are information and data that are authorized by users or fully authorized by parties. In addition, collection, use, and processing of the related data need to comply with related laws, regulations, and standards, and corresponding operation entries are provided for the users' selection of authorization or refusal.

With development of computer technologies, a kernel module is relied on by more and more service components and is used for data transmission. Currently, in a maintenance process of the kernel module, the kernel module needs to be upgraded to improve stability of the kernel module.

In the related art, steps of upgrading the kernel module are as follows: First, disable and deactivate a service component that relies on the kernel module; and then, upgrade the kernel module. For example, the kernel module may be a kernel transmission module, and the kernel transmission module is configured to carry transmission of key data or a control signal of the service component. However, in upgrading a kernel module, a service component that relies on the kernel module needs to be disabled and deactivated, and hence when there are a large number of service components that rely on the kernel module, a large amount of time would be spent on disabling and deactivating the service components. Therefore, efficiency of the foregoing upgrade method is low.

It can be learned that how to implement hot upgrade of the kernel module to improve efficiency of upgrading the kernel module is a technical problem to be solved urgently.

The hot upgrade means upgrading/replacing related software without user perception. This function can improve service availability and eliminate a problem of service unavailability caused by a cold upgrade of a software version in a traditional upgrade scenario. For example, hot upgrade of a kernel-based virtual machine (KVM) mainly solves a problem of service interruption caused by upgrading a virtualization component in a virtual machine scenario.

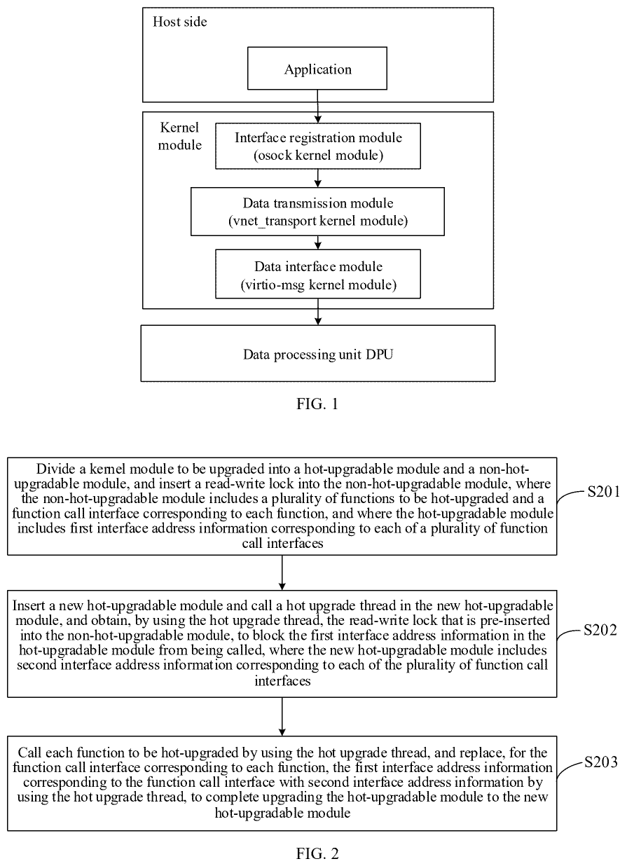

In the present application, taking hot upgrade of a kernel transmission module (sTCP kernel module) as an example, description is made on how to implement hot upgrade of the kernel module. As shown in FIG. 1, the sTCP kernel module is a data transmission channel with high-performance and low-latency, and can implement data transmission between a CPU of a host and a data processing unit (DPU), so that the CPU can offload a load related to processing network packets to the DPU.

For example, when receiving service data sent by a host side (which may be an application), the sTCP kernel module transmits the data to a DPU, for related processing of the data by using a software programmable system (SoC) within the DPU.

It should be noted that the DPU has a logic similar to that of a graphics processing unit (GPU); and the GPU can perform image and graphic-related operation to assume a workload of a CPU. The DPU is also configured to share some complex computations that the CPU is not good at. In an implementation, the DPU may be configured to offload a hypervisor (a supervisory program) in a virtualization scenario, such as virtual storage, a virtual network and other related work. With continued reference to FIG. 1, the sTCP kernel module may include three components:
an interface registration module (an osock kernel module) that is configured to register a socket-related interface and an AF_OSOCK socket family, and call a vnet_transport module to send data;
a data transmission module (a vnet_transport kernel module) that provides a transport layer function, and calls a data interface module (a virtio-msg kernel module) to send data; and
a data interface module (a virtio-msg kernel module) that calls a kernel virtio interface, and transmits data to the DPU by using hardware. The DPU receives the data sent by a front end and performs related processing.

To solve the above problems, this embodiment provides the following technical concept: in upgrading a kernel module, the kernel module may be split into a non-hot-upgradable module and a hot-upgradable module, and a read-write lock is added to the non-hot-upgradable module, and in a normal running process, a read lock needs to be obtained before subsequent operations can be performed, therefore, a hot upgrade thread only needs to obtain a write lock to ensure that calling of the kernel module by all subsequent applications is blocked in the non-hot-upgradable module. In this way, an upgrade environment can be provided for the hot-upgradable module.

Correspondingly, specific steps may include: first, dividing a kernel module to be upgraded into a hot-upgradable module and a non-hot-upgradable module, and inserting a read-write lock into the non-hot-upgradable module, where the non-hot-upgradable module includes a plurality of functions to be hot-upgraded and a function call interface corresponding to each function, and where the hot-upgradable module includes first interface address information corresponding to each of a plurality of function call interfaces; secondly, inserting a new hot-upgradable module and calling a hot upgrade thread in the new hot-upgradable module, and obtaining, by using the hot upgrade thread, the read-write lock pre-inserted into the non-hot-upgradable module, to block the first interface address information in the hot-upgradable module from being called, where the new hot-upgradable module includes second interface address information corresponding to each of the plurality of function call interfaces; finally, calling each function to be hot-upgraded by using the hot upgrade thread, and replacing, for a function call interface corresponding to each function, the first interface address information corresponding to the function call interface with the second interface address information by using the hot upgrade thread, to complete upgrading the hot-upgradable module to the new hot-upgradable module.

In this case, because the read-write lock is inserted into the non-hot-upgradable module, blocking of the first interface address information in the hot-upgradable module from being called is achieved, and an upgrade environment is provided for the hot-upgradable module. In addition, the first interface address information corresponding to the function call interface can be replaced with the second interface address information by using the hot upgrade thread, to implement hot upgrade. In an upgrade process, a related service component does not need to be deactivated, thereby improving upgrade efficiency. In addition, because the service component is in an online state in the upgrade process, related software can be upgraded/replaced without user perception, thereby improving user experience.

Detailed embodiments are used below to describe the hot upgrade method for the kernel module provided in the embodiments of the present disclosure in detail. In this embodiment, the kernel module includes a basic module, a hot-upgradable module, and a newly inserted hot upgrade updating module. The hot-upgradable module is a part in the kernel module that supports a hot upgrade operation; and the non-hot-upgradable module is configured to support hot upgrade of the hot-upgradable module. In this embodiment, description is made by taking an example in which the basic module is a non-hot-upgradable module and the hot upgrade updating module is a new hot-upgradable module.

FIG. 2 is a flowchart of a hot upgrade method for a kernel module according to an embodiment of the present disclosure. An execution subject of this method may be an electronic device, or may be a server device. Description is made in this embodiment of the present application by taking an example where the execution subject is the electronic device. As shown in FIG. 2, the method includes the following steps.

S201: Divide a kernel module to be upgraded into a hot-upgradable module and a non-hot-upgradable module, and insert a read-write lock into the non-hot-upgradable module, where the non-hot-upgradable module includes a plurality of functions to be hot-upgraded and a function call interface corresponding to each function, and where the hot-upgradable module includes first interface address information corresponding to each of a plurality of function call interfaces.

In the embodiments of the present disclosure, the kernel module may be any kernel module that needs to be upgraded in an electronic device. In an implementation, the kernel module may be an sTCP kernel module. In upgrading the sTCP kernel module, mainly an interface registration module (an osock kernel module) and a data transmission module (a vnet_transport kernel module) in the kernel module are to be upgraded. These two kernel modules undertake most of service logic. Description is made below with examples of implementing hot upgrade of the interface registration module (the osock kernel module) and the data transmission module (the vnet_transport kernel module).

In some embodiments, the kernel module includes the interface registration module, and the interface registration module is divided into a hot-upgradable registration module and a non-hot-upgradable registration module. In this case, the basic module includes the non-hot-upgradable registration module, and the hot-upgradable module includes the hot-upgradable registration module.

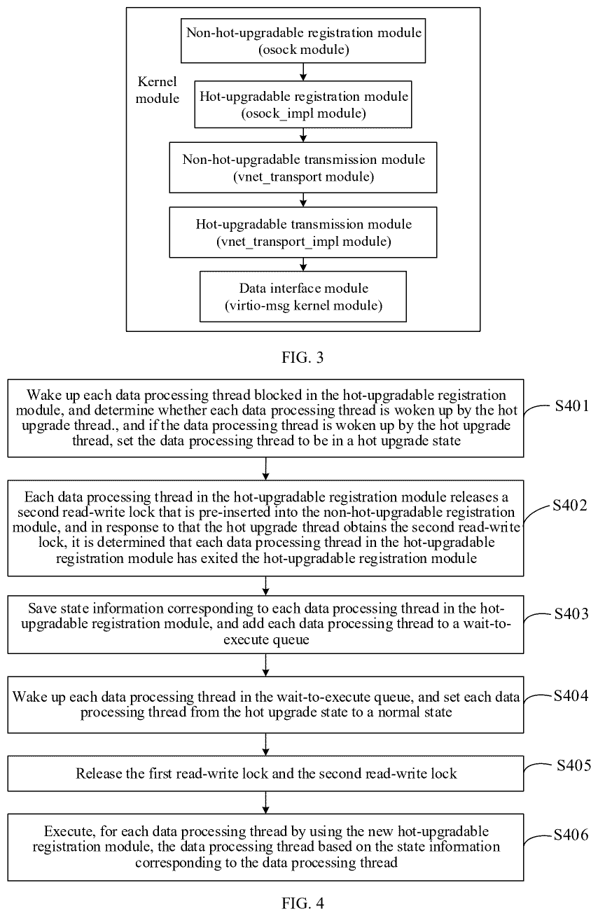

For example, as shown in FIG. 3, the hot-upgradable registration module may be represented by an osock_impl module, and the non-hot-upgradable registration module may be represented by an osock module.

In some other embodiments, the kernel module further includes the data transmission module, and the data transmission module is divided into a hot-upgradable transmission module and a non-hot-upgradable transmission module. In this case, the basic module includes the non-hot-upgradable registration module and the non-hot-upgradable transmission module. The hot-upgradable module includes the hot-upgradable registration module and the hot-upgradable transmission module.

For example, as shown in FIG. 3, the hot-upgradable transmission module may be represented by a vnet_transport_impl module, and the non-hot-upgradable transmission module may be represented by a vnet_transport module.

S202: Insert a new hot-upgradable module and call a hot upgrade thread in the new hot-upgradable module, and obtain, by using the hot upgrade thread, the read-write lock pre-inserted into the non-hot-upgradable module, to block the first interface address information in the hot-upgradable module from being called, where the new hot-upgradable module includes second interface address information corresponding to each of the plurality of function call interfaces.

In an implementation, the second interface address information corresponding to each of the plurality of function call interfaces may be stored in the new hot-upgradable module (that is, the hot upgrade updating module) before hot upgrade. In some embodiments, in hot-upgrading the interface registration module, the new hot-upgradable registration module may be represented as a new osock_impl module. The new osock_impl module includes plural pieces of socket-related interface address information therein, for example, sendmsg interface address information, recvmsg interface address information, and accept interface address information. In some other embodiments, in hot-upgrading the data transmission module, the new hot-upgradable transmission module may be represented as a new vnet_transport_impl module. The new vnet_transport_impl module includes plural pieces of transport layer interface address information. In an implementation, when the kernel module needs to be hot-upgraded, a hot upgrade updating module may be inserted by using insmod (load module).

In some embodiments, the kernel module includes the interface registration module. The hot-upgradable module of the kernel module includes the hot-upgradable registration module, and the basic module (that is, the non-hot-upgradable module) of the kernel module includes the non-hot-upgradable registration module. The read-write lock includes a first read-write lock, and the first read-write lock is used for an application to call a function call interface in the non-hot-upgradable registration module. Correspondingly, the obtaining, by using the hot upgrade thread, the read-write lock pre-inserted into the non-hot-upgradable module, to block the first interface address information in the hot-upgradable module from being called includes: obtaining, by using the hot upgrade thread, a first read-write lock pre-inserted into a non-hot-upgradable registration module in the basic module, and blocking the application from calling a function call interface in the non-hot-upgradable registration module, to block the first interface address information in the hot-upgradable registration module from being called.

The first read-write lock may be an osock_rwlock read-write lock, and when calling all osock layer interfaces, a kernel needs to obtain a read lock before performing a subsequent operation. In some embodiments, the hot upgrade thread may obtain the first read-write lock by using a preset obtaining function. In an implementation, the preset obtaining function may be a down_write_trylock function.

It should be noted that when the new hot-upgradable registration module (the new osock_impl module) is inserted, a state of the new hot-upgradable registration module (the new osock_impl module) may be set to a hot upgrade state. In an implementation, the state of the new osock_impl module may be set to the hot upgrade state by adding an is_live_upgrade parameter.

In some other embodiments, the kernel module further includes the data transmission module, the data transmission module is configured to receive and transmit a data stream sent by the interface registration module, the hot-upgradable module further includes a hot-upgradable transmission module, and the basic module (that is, the non-hot-upgradable module) further includes a non-hot-upgradable transmission module. The read-write lock includes a third read-write lock, and the third read-write lock is used for the interface registration module to call the non-hot-upgradable transmission module. Correspondingly, the obtaining, by using the hot upgrade thread, the read-write lock pre-inserted into the non-hot-upgradable module, to block the first interface address information in the hot-upgradable module from being called includes: obtaining, by using the hot upgrade thread, a third read-write lock pre-inserted into a non-hot-upgradable transmission module in the basic module, and blocking the interface registration module from calling a function call interface in the non-hot-upgradable transmission module, to block the first interface address information in the hot-upgradable transmission module from being called; and calling a pause function in the hot-upgradable transmission module, and setting a callback function for receiving a data stream in the hot-upgradable transmission module as invalid, to block the hot-upgradable transmission module from receiving the data stream. For example, the pause function may be represented as a Pause function.

The third read-write lock may be a trans_rwlock read-write lock, and when calling a function in the data transmission module (the vnet_transport module), all hot-upgradable registration modules (osock_impl modules) need to obtain a read lock before performing a subsequent operation. In some embodiments, the hot upgrade thread may obtain the third read-write lock by using a preset obtaining function. In an implementation, the preset obtaining function may be a down_write_trylock function.

It should be noted that when the new hot-upgradable transmission module (the new vnet_transport_impl module) is inserted, a state of the new hot-upgradable transmission module (the new vnet_transport_impl module) may be set to a hot upgrade state. In an implementation, the state of the new vnet_transport_impl module may be set to the hot upgrade state by adding an is_live_upgrade parameter.

S203: Call each function to be hot-upgraded by using the hot upgrade thread, and replace, for the function call interface corresponding to each function, the first interface address information corresponding to the function call interface with the second interface address information by using the hot upgrade thread, to complete upgrading the hot-upgradable module to the new hot-upgradable module.

In some embodiments, the kernel module to be upgraded includes the interface registration module. A hot-upgradable registration module in the interface registration module may be represented by an old socket_impl module. The newly inserted hot upgrade updating module includes a new hot-upgradable registration module, and the new hot-upgradable registration module may be represented by a new osock_impl module. For example, the old socket_impl module includes a plurality of pieces of first interface address information (for example, old socket interface address information). The new osock_impl module includes a plurality of pieces of second interface address information (for example, new socket interface address information). Correspondingly, the replacing, for the function call interface corresponding to each function, the first interface address information corresponding to the function call interface with the second interface address information by using the hot upgrade thread includes: replacing, by using the hot upgrade thread, old socket interface address information corresponding to the function call interface with new socket interface address information.

In this case, a process of upgrading the hot-upgradable module to the new hot-upgradable module is a process of replacing the hot-upgradable registration module (the old osock_impl module) with the new hot-upgradable registration module (the new osock_impl module).

In some other embodiments, the kernel module to be upgraded further includes the data transmission module. A hot-upgradable transmission module in the data transmission module may be represented by an old vnet_transport_impl module. The newly inserted hot upgrade updating module includes a new hot-upgradable transmission module, and the new hot-upgradable transmission module may be represented by a new vnet_transport_impl module. For example, the old vnet_transport_impl module includes a plurality of pieces of first interface address information (for example, old transport layer interface address information). The new vnet_transport_impl module includes a plurality of pieces of second interface address information (for example, new transport layer interface address information). Correspondingly, the replacing, for the function call interface corresponding to each function, the first interface address information corresponding to the function call interface with the second interface address information by using the hot upgrade thread includes: replacing, by using the hot upgrade thread, old transport layer interface address information corresponding to the function call interface with new transport layer interface address information.

In this case, a process of upgrading the hot-upgradable module to the new hot-upgradable module is a process of replacing the hot-upgradable transmission module (the old vnet_transport_impl module) with the new hot-upgradable transmission module (the new vnet_transport_impl module).

The hot upgrade method for the kernel module provided in this embodiment includes: dividing a kernel module to be upgraded into a hot-upgradable module and a non-hot-upgradable module, and inserting a read-write lock into the non-hot-upgradable module, where the non-hot-upgradable module includes a plurality of function call interfaces, and the hot-upgradable module includes first interface address information corresponding to each of the plurality of function call interfaces; inserting a new hot-upgradable module and calling a hot upgrade thread, and obtaining, by using the hot upgrade thread, the read-write lock pre-inserted into the non-hot-upgradable module, to block the first interface address information in the hot-upgradable module from being called, where the new hot-upgradable module includes second interface address information corresponding to each of the plurality of function call interfaces; and replacing, for each function call interface, the first interface address information corresponding to the function call interface with the second interface address information by using the hot upgrade thread, to complete upgrading the hot-upgradable module to the new hot-upgradable module. In the embodiments of the present application, because the read-write lock is inserted into the non-hot-upgradable module, blocking of the first interface address information in the hot-upgradable module from being called is achieved, and an upgrade environment is provided for the hot-upgradable module. In addition, the first interface address information corresponding to the function call interface can be replaced with the second interface address information by using the hot upgrade thread, to implement hot upgrade. In an upgrade process, a related service component does not need to be deactivated, thereby improving upgrade efficiency. In addition, because the service component is in an online state in the upgrade process, related software can be upgraded/replaced without user perception, thereby improving user experience.

It should be noted that an osock module and a transport module each contain state information, mainly including socket information, a task that already exists in a work queue, data that has been submitted to the work queue and is to be sent, data that is received but not processed, and data that has been sent/received when sending and receiving are blocked. Therefore, during hot upgrade of the kernel module, a processing method for related states and an impact that may be caused to another part of the kernel during processing of the related states need to be considered.

In some embodiments, the kernel module to be upgraded includes the interface registration module (the osock module). Before the osock module is upgraded, data in the osock module needs to be processed. In an implementation, the read-write lock pre-inserted into the non-hot-upgradable registration module further includes a second read-write lock, and the second read-write lock is used for calling a thread blocked in the hot-upgradable registration module. For example, the second read-write lock is a block_rwlock read-write lock.

Correspondingly, as shown in FIG. 4, before the replacing, for each function call interface, the first interface address information corresponding to the function call interface with the second interface address information by using the hot upgrade thread, to complete upgrading the hot-upgradable module to the new hot-upgradable module, the data in the osock module needs to be processed. Specific steps may include the following steps.

S401: Wake up each data processing thread blocked in the hot-upgradable registration module, and determine whether each data processing thread is woken up by the hot upgrade thread; and if the data processing thread is woken up by the hot upgrade thread, set the data processing thread to be in a hot upgrade state.

In an implementation, the data processing thread may include one or more of a sendmsg thread, a recvmsg thread, and an accept thread. In some embodiments, a sk_state_change function may be called to wake up the sendmsg thread, the recvmsg thread, and the accept thread that are blocked in the hot-upgradable registration module (the old osock_impl module).

It should be noted that the data processing thread may be woken up during hot upgrade or non-hot upgrade. If the data processing thread is not woken up by the hot upgrade thread, it is determined that a current situation is a non-hot upgrade situation, and the data processing thread runs normally. In this case, step S402 and step S403 are not performed.

S402: Each data processing thread in the hot-upgradable registration module releases the second read-write lock pre-inserted into the non-hot-upgradable registration module, and in response to that the hot upgrade thread obtains the second read-write lock, it is determined that each data processing thread in the hot-upgradable registration module has exited the hot-upgradable registration module.

In this step, after each data processing thread in the hot-upgradable registration module releases the second read-write lock, the hot upgrade thread can obtain the second read-write lock. After the hot upgrade thread obtains the second read-write lock, it is determined that each data processing thread in the hot-upgradable registration module has exited the hot-upgradable registration module. In this case, there is no data processing thread in the hot-upgradable registration module, and the hot-upgradable registration module can be upgraded (that is, a hot upgrade environment is available).

In this case, the second read-write lock pre-inserted into the non-hot-upgradable registration module is used to exit each data processing thread in the hot-upgradable registration module from the hot-upgradable registration module, thereby providing a hot upgrade environment for the hot-upgradable registration module.

S403: Save state information corresponding to each data processing thread in the hot-upgradable registration module, and add the data processing thread to a wait-to-execute queue.

For example, the wait-to-execute queue may be represented as a wait_queue.

In an implementation, with continued reference to FIG. 4, after the replacing, for each function call interface, the first interface address information corresponding to the function call interface with the second interface address information by using the hot upgrade thread, to complete upgrading the hot-upgradable module to the new hot-upgradable module, the method further includes the following.

S404: Wake up each data processing thread in the wait-to-execute queue, and set each data processing thread from the hot upgrade state to a normal state.

S405: Release the first read-write lock and the second read-write lock.

S406: Execute, for each data processing thread by using the new hot-upgradable registration module, the data processing thread based on the state information corresponding to the data processing thread.

In this step, the hot-upgradable registration module in the interface registration module may be represented by the old socket_impl module. The newly inserted hot upgrade updating module includes the new hot-upgradable registration module, and the new hot-upgradable registration module may be represented by the new osock_impl module. It should be noted that after hot upgrade succeeds, a service interruption time (that is, a hot upgrade time) may be further recorded. In an implementation, the old hot-upgradable registration module (the old osock_impl module) may be safely removed by using rmmod (unload module). The hot upgrade process is a process of replacing the old osock_impl module with the new osock_impl module.

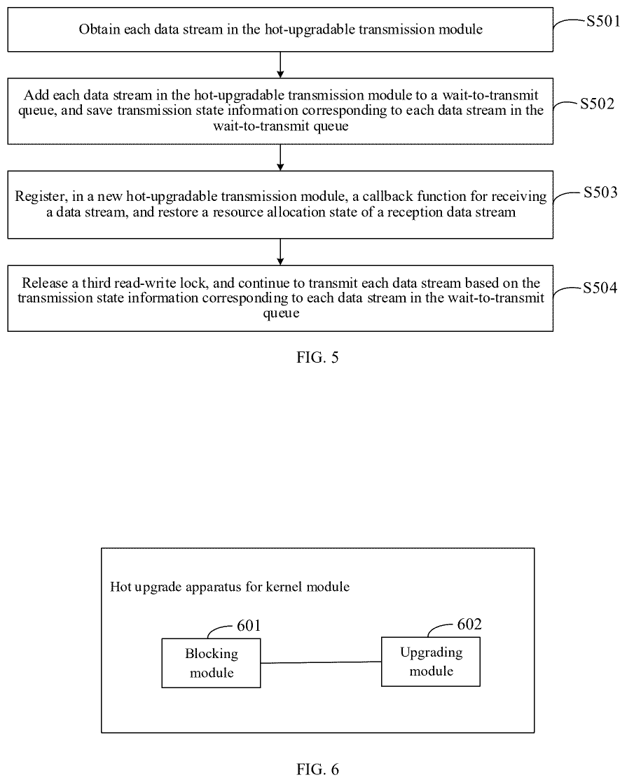

In some other embodiments, the kernel module to be upgraded further includes a data transmission module (transport module). Correspondingly, as shown in FIG. 5, before the replacing, for each function call interface, the first interface address information corresponding to the function call interface with the second interface address information by using the hot upgrade thread, to complete upgrading the hot-upgradable module to the new hot-upgradable module, the data in the transport module needs to be processed. Specific steps may include the following steps.

S501: Obtain each data stream in the hot-upgradable transmission module.

S502: Add each data stream in the hot-upgradable transmission module to a wait-to-transmit queue, and save transmission state information corresponding to each data stream in the wait-to-transmit queue.

In the embodiments of the present disclosure, the data stream may include a transmission (TX) data stream and a reception (RX) data stream. In an implementation, the transmission state information corresponding to each data stream may be saved by calling a save function in the hot-upgradable transmission module (the old vnet_transport_impl module).

In some embodiments, the data stream is the transmission data stream. Correspondingly, the adding each data stream in the hot-upgradable transmission module to the wait-to-transmit queue, and the saving the transmission state information corresponding to each data stream in the wait-to-transmit queue may include the following steps (a1) to (a3).

(a1) For each data stream, if a transmission direction of the data stream is from the kernel module to a data processing unit, determine whether a retransmitted data stream in a sending state exists in a data retransmission queue, where the data retransmission queue is used to maintain a data stream that is retransmitted from the kernel module to the processor.

The data retransmission queue may be represented as a retransmit queue.

(a2) If yes, add the data stream to the data retransmission queue when transmission of the retransmitted data stream in the sending state ends, delete a retransmission timer corresponding to the data retransmission queue when the addition is completed, and save a transmission state of each data stream maintained in the data retransmission queue.

The transmission state information corresponding to the data stream is used to indicate a current working state of the data stream. In an implementation, the transmission state information corresponding to the data stream includes: being created, created, being sent, being closed, closed, and the like.

(a3) If no, determine whether an initial transmitted data stream in a sending state exists in a data sending queue. If yes, add the data stream to the data sending queue when transmission of the initial transmitted data stream in the sending state ends, and save a transmission state of each data stream maintained in a data transmission queue when the addition is completed. The data sending queue may be represented as a tx fair queue.

In some other embodiments, the data stream is the reception data stream.

Correspondingly, the adding each data stream in the hot-upgradable transmission module to the wait-to-transmit queue, and the saving the transmission state information corresponding to each data stream in the wait-to-transmit queue may include the following steps (b1) to (b3).

(b1) For each data stream, if a transmission direction of the data stream is from a data processing unit to the kernel module, determine a data type of the data stream.

(b2) If the data type is control data, add the data stream to a data control queue, and save a transmission state of each data stream maintained in the data control queue when the addition is completed.

The data control queue may be represented as an rx ctrl work_queue.

(b3) If the data type is non-control data, add the data stream to a data interface queue, and

save a transmission state of each data stream maintained in the data interface queue when the addition is completed.

The data interface queue may be represented as a sock rx skb list.

In this case, the adding each data stream in the hot-upgradable transmission module to the wait-to-transmit queue, and the saving the transmission state information corresponding to each data stream in the wait-to-transmit queue are used to exit each data stream in the hot-upgradable transmission module from the hot-upgradable transmission module, thereby providing a hot upgrade environment for the hot-upgradable transmission module.

In an implementation, with continued reference to FIG. 5, after the replacing, for each function call interface, the first interface address information corresponding to the function call interface with the second interface address information by using the hot upgrade thread, to complete upgrading the hot-upgradable module to the new hot-upgradable module, the method further includes the following.

S503: Register, in the new hot-upgradable transmission module, a callback function for receiving a data stream, and restore a resource allocation state of a reception data stream.

In the embodiments of the present disclosure, the callback function for receiving the data stream needs to be registered before the data stream can be further processed.

It should be noted that before the callback function is registered, state information related to the data stream in the old vnet_transport_impl module further needs to be migrated to the new vnet_transport_impl module. Migration of the state information of the data stream may be completed by initializing the new vnet_transport_impl module.

In some embodiments, an initialization process of the new vnet_transport_impl module may include the following steps. First, call a restore function in the new vnet_transport_impl by using a state saved in the old vnet_transport_impl module as a parameter, to initialize a device address and initialize resource allocation. Secondly, for each data stream, restore mapping between a data stream identifier (that is, a data stream id) and an internal state of the data stream. Then, restore an internal state of a vnet_transport_impl layer that is saved previously. Finally, initialize a tasklet (task list) and a timer of a data retransmission queue (retransmit queue) and an rx ctrl work_queue (data control queue).

S504: Release a third read-write lock, and continue to transmit each data stream based on the transmission state information corresponding to each data stream in the wait-to-transmit queue.

It should be noted that after hot upgrade succeeds, a service interruption time (that is, a hot upgrade time) may be further recorded. In an implementation, the old hot-upgradable transmission module (the old vnet_transport_impl module) may be safely removed by using rmmod (unload module).

FIG. 6 is a block diagram of a structure of a hot upgrade apparatus for a kernel module according to an embodiment of the present disclosure. The apparatus includes: a blocking module 601 and an upgrading module 602.

The blocking module 601 is configured to: when a hot upgrade request for the kernel module is triggered, call a hot upgrade thread in a newly inserted hot upgrade updating module, and obtain, by using the hot upgrade thread, a read-write lock that is pre-inserted into a basic module in the kernel module, to block first interface address information of a hot-upgradable module in the kernel module from being called, where the hot upgrade updating module includes second interface address information corresponding to each of a plurality of function call interfaces; and where the kernel module includes the basic module and the hot-upgradable module, the hot-upgradable module is a part in the kernel module that supports a hot upgrade operation, and the basic module is configured to support hot upgrade of the hot-upgradable module.

The upgrading module 602 is configured to: call each function to be hot-upgraded by using the hot upgrade thread, and replace, for a function call interface corresponding to each function, the first interface address information corresponding to the function call interface with the second interface address information by using the hot upgrade thread, to complete hot upgrade for the kernel module.

According to one or more embodiments of the present disclosure, the kernel module includes an interface registration module. Correspondingly, the blocking module 601 is configured to obtain, by using the hot upgrade thread, the read-write lock that is pre-inserted into the basic module in the kernel module, to block the first interface address information of the hot-upgradable module in the kernel module from being called, and is specifically configured to obtain, by using the hot upgrade thread, a first read-write lock that is pre-inserted into a non-hot-upgradable registration module in the basic module, and block an application from calling a function call interface in the non-hot-upgradable registration module, to block the first interface address information in the hot-upgradable registration module from being called.

According to one or more embodiments of the present disclosure, the read-write lock further includes a second read-write lock, and the second read-write lock is used for calling a thread blocked in the hot-upgradable registration module. Correspondingly, the apparatus further includes a data saving module. The data saving module is configured to: wake up each data processing thread blocked in the hot-upgradable registration module, and determine whether each data processing thread is woken up by the hot upgrade thread; and if the data processing thread is woken up by the hot upgrade thread, set the data processing thread to be in a hot upgrade state. Each data processing thread in the hot-upgradable registration module releases the second read-write lock pre-inserted into the non-hot-upgradable registration module in the basic module. In response to that the hot upgrade thread obtains the second read-write lock, it is determined that each data processing thread in the hot-upgradable registration module has exited the hot-upgradable registration module. Save state information corresponding to each data processing thread in the hot-upgradable registration module, and add each data processing thread in the hot-upgradable registration module to a wait-to-execute queue.

According to one or more embodiments of the present disclosure, the apparatus further includes a wake-up module. The wake-up module is configured to: wake up each data processing thread in the wait-to-execute queue, and set each data processing thread from the hot upgrade state to a normal state; release the first read-write lock and the second read-write lock; and for each data processing thread, execute the data processing thread by using the new hot-upgradable module based on the state information corresponding to the data processing thread.

According to one or more embodiments of the present disclosure, the kernel module further includes a data transmission module, and the data transmission module is configured to transmit a data stream sent by the interface registration module. Correspondingly, the blocking module 601 is configured to obtain, by using the hot upgrade thread, the read-write lock that is pre-inserted into the basic module in the kernel module, to block the first interface address information of the hot-upgradable module in the kernel module from being called, and is specifically configured to obtain, by using the hot upgrade thread, a third read-write lock that is pre-inserted into a non-hot-upgradable transmission module in the basic module, and block the interface registration module from calling a function call interface in the non-hot-upgradable transmission module, to block the first interface address information in a hot-upgradable transmission module from being called; and call a pause function in the hot-upgradable transmission module, and set a callback function for receiving a data stream in the hot-upgradable transmission module as invalid, to block the hot-upgradable transmission module from receiving the data stream.

According to one or more embodiments of the present disclosure, the data saving module is further configured to: obtain each data stream in a hot-upgradable transmission module; and add each data stream in the hot-upgradable transmission module to a wait-to-transmit queue, and save transmission state information corresponding to each data stream in the wait-to-transmit queue.

According to one or more embodiments of the present disclosure, the data saving module is configured to add each data stream in the hot-upgradable transmission module to the wait-to-transmit queue, and save the transmission state information corresponding to each data stream in the wait-to-transmit queue, and is specifically configured to: for each data stream, if a transmission direction of the data stream is from the kernel module to a data processing unit, determine whether a retransmitted data stream in a sending state exists in a data retransmission queue, where the data retransmission queue is used to maintain a data stream that is retransmitted from the kernel module to the processor; if yes, add the data stream to the data retransmission queue when transmission of the retransmitted data stream in the sending state ends, delete a retransmission timer corresponding to the data retransmission queue when the addition is completed, and save a transmission state of each data stream maintained in the data retransmission queue; or if no, determine whether an initial transmitted data stream in a sending state exists in a data transmission queue; if yes, add the data stream to the data transmission queue when transmission of the initial transmitted data stream in the sending state ends, and save a transmission state of each data stream maintained in the data transmission queue when the addition is completed.

According to one or more embodiments of the present disclosure, the data saving module is configured to add each data stream in the hot-upgradable transmission module to the wait-to-transmit queue, and save the transmission state information corresponding to each data stream in the wait-to-transmit queue, and is specifically configured to: for each data stream, if a transmission direction of the data stream is from a data processing unit to the kernel module, determine a data type of the data stream; if the data type is control data, add the data stream to a data control queue, and save a transmission state of each data stream maintained in the data control queue when the addition is completed; or if the data type is non-control data, add the data stream to a data interface queue, and save a transmission state of each data stream maintained in the data interface queue when the addition is completed.

According to one or more embodiments of the present disclosure, the apparatus further includes a registration module. The registration module is configured to: register, in the new hot-upgradable transmission module, a callback function for receiving a data stream, and restore a resource allocation state of a reception data stream; and release the third read-write lock, and continue to transmit each data stream based on the transmission state information corresponding to each data stream in the wait-to-transmit queue.

The blocking module 601 and the upgrading module 602 are connected in sequence. The hot upgrade apparatus for the kernel module according to this embodiment may perform the technical solution of the method embodiment; the implementation principle and technical effects therebetween are similar, and details are not described herein again in this embodiment.

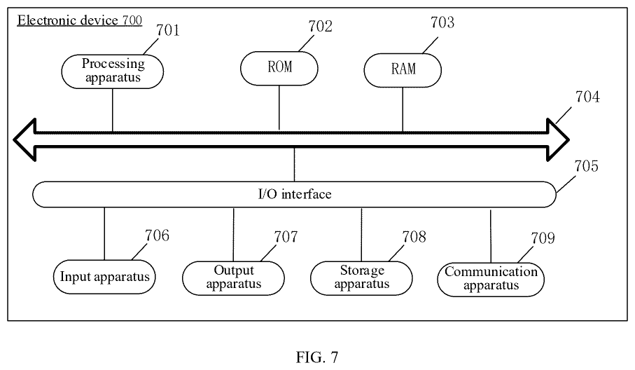

FIG. 7 is a schematic diagram of a hardware structure of an electronic device according to an embodiment of the present disclosure. With reference to FIG. 7, the electronic device 700 may be a terminal device or a server. The terminal device may include, but is not limited to, mobile terminals such as a mobile phone, a notebook computer, a digital broadcast receiver, a personal digital assistant (PDA for short), a tablet computer (Portable Android Device, PAD for short), a portable multimedia player (PMP for short), and a vehicle-mounted terminal (for example, a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (for example, a central processing unit, a graphics processing unit, etc.) 701, which may perform a variety of appropriate actions and processing in accordance with a program stored in a read-only memory (ROM for short) 702 or a program loaded from a storage apparatus 708 into a random access memory (RAM for short) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD for short), a speaker, and a vibrator; a storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses. In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN for short) or a wide area network (WAN for short), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments described in the present disclosure may be implemented by means of software, or may be implemented by means of hardware. The name of a unit does not constitute a limitation on the unit itself in some cases. For example, a first obtaining unit may alternatively be described as “a unit for obtaining at least two Internet protocol addresses”.

The functions described herein above may be performed, at least partially, by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

In a first aspect, according to one or more embodiments of the present disclosure, there is provided a hot upgrade method for a kernel module, including:
when a hot upgrade request for the kernel module is triggered, calling a hot upgrade thread in a newly inserted hot upgrade updating module, and obtaining, by using the hot upgrade thread, a read-write lock that is pre-inserted into a basic module in the kernel module, to block first interface address information of a hot-upgradable module in the kernel module from being called, where the hot upgrade updating module includes second interface address information corresponding to each of a plurality of function call interfaces; and where the kernel module includes the basic module and the hot-upgradable module, the hot-upgradable module is a part in the kernel module that supports a hot upgrade operation, and the basic module is configured to support hot upgrade of the hot-upgradable module; and
calling each function to be hot-upgraded by using the hot upgrade thread, and replacing, for a function call interface corresponding to each function, the first interface address information corresponding to the function call interface with the second interface address information by using the hot upgrade thread, to complete hot upgrade for the kernel module.

According to one or more embodiments of the present disclosure, the kernel module includes an interface registration module. Correspondingly, the obtaining, by using the hot upgrade thread, the read-write lock that is pre-inserted into the basic module in the kernel module, to block the first interface address information of the hot-upgradable module in the kernel module from being called includes: obtaining, by using the hot upgrade thread, a first read-write lock that is pre-inserted into a non-hot-upgradable registration module in the basic module, and blocking an application from calling a function call interface in the non-hot-upgradable registration module, to block the first interface address information in the hot-upgradable registration module from being called.

According to one or more embodiments of the present disclosure, the read-write lock further includes a second read-write lock, and the second read-write lock is used for calling a thread blocked in the hot-upgradable registration module. Correspondingly, before the calling each function to be hot-upgraded by using the hot upgrade thread, and the replacing, for the function call interface corresponding to each function, the first interface address information corresponding to the function call interface with the second interface address information by using the hot upgrade thread, to complete the hot upgrade for the kernel module, the method further includes: waking up each data processing thread blocked in the hot-upgradable registration module, and determining whether each data processing thread is woken up by the hot upgrade thread; and if the data processing thread is woken up by the hot upgrade thread, setting the data processing thread to be in a hot upgrade state. Each data processing thread in the hot-upgradable registration module releases the second read-write lock pre-inserted into the non-hot-upgradable registration module in the basic module. In response to that the hot upgrade thread obtains the second read-write lock, it is determined that each data processing thread in the hot-upgradable registration module has exited the hot-upgradable registration module. Save state information corresponding to each data processing thread in the hot-upgradable registration module, and add each data processing thread in the hot-upgradable registration module to a wait-to-execute queue.

According to one or more embodiments of the present disclosure, the hot upgrade updating module includes a new hot-upgradable registration module. After the calling each function to be hot-upgraded by using the hot upgrade thread, and the replacing, for the function call interface corresponding to each function, the first interface address information corresponding to the function call interface with the second interface address information by using the hot upgrade thread, to complete the hot upgrade for the kernel module, the method further includes: waking up each data processing thread in the wait-to-execute queue, and setting a state of each data processing thread from the hot upgrade state to a normal state; releasing the first read-write lock and the second read-write lock; and for each data processing thread, executing the data processing thread by using the new hot-upgradable module based on the state information corresponding to the data processing thread.

According to one or more embodiments of the present disclosure, the kernel module further includes a data transmission module, and the data transmission module is configured to transmit a data stream sent by the interface registration module. Correspondingly, the obtaining, by using the hot upgrade thread, the read-write lock that is pre-inserted into the basic module in the kernel module, to block the first interface address information of the hot-upgradable module in the kernel module from being called includes: obtaining, by using the hot upgrade thread, a third read-write lock that is pre-inserted into a non-hot-upgradable transmission module in the basic module, and blocking the interface registration module from calling a function call interface in the non-hot-upgradable transmission module, to block the first interface address information in a hot-upgradable transmission module from being called; and calling a pause function in the hot-upgradable transmission module, and setting a callback function for receiving a data stream in the hot-upgradable transmission module as invalid, to block the hot-upgradable transmission module from receiving the data stream.

According to one or more embodiments of the present disclosure, before the calling each function to be hot-upgraded by using the hot upgrade thread, and the replacing, for a function call interface corresponding to each function, the first interface address information corresponding to the function call interface with the second interface address information by using the hot upgrade thread, to complete the hot upgrade for the kernel module, the method further includes: obtaining each data stream in a hot-upgradable transmission module; and adding each data stream in the hot-upgradable transmission module to a wait-to-transmit queue, and saving transmission state information corresponding to each data stream in the wait-to-transmit queue.

According to one or more embodiments of the present disclosure, the adding each data stream in the hot-upgradable transmission module to the wait-to-transmit queue, and the saving the transmission state information corresponding to each data stream in the wait-to-transmit queue include: for each data stream, if a transmission direction of the data stream is from the kernel module to a data processing unit, determine whether a retransmitted data stream in a sending state exists in a data retransmission queue, where the data retransmission queue is used to maintain a data stream that is retransmitted from the kernel module to the processor; if yes, add the data stream to the data retransmission queue when transmission of the retransmitted data stream in the sending state ends, delete a retransmission timer corresponding to the data retransmission queue when the addition is completed, and save a transmission state of each data stream maintained in the data retransmission queue; or if no, determine whether an initial transmitted data stream in a sending state exists in a data transmission queue. If yes, add the data stream to the data transmission queue when transmission of the initial transmitted data stream in the sending state ends, and save a transmission state of each data stream maintained in the data transmission queue when the addition is completed.

According to one or more embodiments of the present disclosure, the adding each data stream in the hot-upgradable transmission module to the wait-to-transmit queue, and the saving the transmission state information corresponding to each data stream in the wait-to-transmit queue include: for each data stream, if a transmission direction of the data stream is from a data processing unit to the kernel module, determine a data type of the data stream; if the data type is control data, add the data stream to a data control queue, and save a transmission state of each data stream maintained in the data control queue when the addition is completed; or if the data type is non-control data, add the data stream to a data interface queue, and save a transmission state of each data stream maintained in the data interface queue when the addition is completed.

According to one or more embodiments of the present disclosure, the hot upgrade updating module includes a new hot-upgradable transmission module. After the calling each function to be hot-upgraded by using the hot upgrade thread, and the replacing, for the function call interface corresponding to each function, the first interface address information corresponding to the function call interface with the second interface address information by using the hot upgrade thread, to complete the hot upgrade for the kernel module, the method further includes: registering, in the new hot-upgradable transmission module, a callback function for receiving a data stream, and restoring a resource allocation state of a reception data stream; and releasing the third read-write lock, and continue to transmit each data stream based on the transmission state information corresponding to each data stream in the wait-to-transmit queue.

In a second aspect, according to one or more embodiments of the present disclosure, there is provided a hot upgrade apparatus for a kernel module, the apparatus including:
a blocking module, configured to: when a hot upgrade request for the kernel module is triggered, call a hot upgrade thread in a newly inserted hot upgrade updating module, and obtain, by using the hot upgrade thread, a read-write lock that is pre-inserted into a basic module in the kernel module, to block first interface address information of a hot-upgradable module in the kernel module from being called, where the hot upgrade updating module includes second interface address information corresponding to each of a plurality of function call interfaces; and where the kernel module includes the basic module and the hot-upgradable module, the hot-upgradable module is a part in the kernel module that supports a hot upgrade operation, and the basic module is configured to support hot upgrade of the hot-upgradable module; and
an upgrading module, configured to: call each function to be hot-upgraded by using the hot upgrade thread, and replace, for a function call interface corresponding to each function, the first interface address information corresponding to the function call interface with the second interface address information by using the hot upgrade thread, to complete hot upgrade for the kernel module.

According to one or more embodiments of the present disclosure, the kernel module includes an interface registration module. Correspondingly, the blocking module is configured to obtain, by using the hot upgrade thread, the read-write lock that is pre-inserted into the basic module in the kernel module, to block the first interface address information of the hot-upgradable module in the kernel module from being called, and is specifically configured to obtain, by using the hot upgrade thread, a first read-write lock that is pre-inserted into a non-hot-upgradable registration module in the basic module, and block an application from calling a function call interface in the non-hot-upgradable registration module, to block the first interface address information in the hot-upgradable registration module from being called.

According to one or more embodiments of the present disclosure, the read-write lock further includes a second read-write lock, and the second read-write lock is used for calling a thread blocked in the hot-upgradable registration module. Correspondingly, the apparatus further includes a data saving module. The data saving module is configured to: wake up each data processing thread blocked in the hot-upgradable registration module, and determine whether each data processing thread is woken up by the hot upgrade thread; and if the data processing thread is woken up by the hot upgrade thread, set the data processing thread to be in a hot upgrade state. Each data processing thread in the hot-upgradable registration module releases the second read-write lock pre-inserted into the non-hot-upgradable registration module in the basic module. In response to that the hot upgrade thread obtains the second read-write lock, it is determined that each data processing thread in the hot-upgradable registration module has exited the hot-upgradable registration module. Save state information corresponding to each data processing thread in the hot-upgradable registration module, and add each data processing thread in the hot-upgradable registration module to a wait-to-execute queue.

According to one or more embodiments of the present disclosure, the apparatus further includes a wake-up module. The wake-up module is configured to: wake up each data processing thread in the wait-to-execute queue, and set a state of each data processing thread from the hot upgrade state to a normal state; release the first read-write lock and the second read-write lock; and for each data processing thread, execute the data processing thread by using the new hot-upgradable module based on the state information corresponding to the data processing thread.

According to one or more embodiments of the present disclosure, the kernel module further includes a data transmission module, and the data transmission module is configured to transmit a data stream sent by the interface registration module. Correspondingly, the blocking module is configured to obtain, by using the hot upgrade thread, the read-write lock that is pre-inserted into the basic module in the kernel module, to block the first interface address information of the hot-upgradable module in the kernel module from being called, and is specifically configured to obtain, by using the hot upgrade thread, a third read-write lock that is pre-inserted into a non-hot-upgradable transmission module in the basic module, and block the interface registration module from calling a function call interface in the non-hot-upgradable transmission module, to block the first interface address information in a hot-upgradable transmission module from being called; and call a pause function in the hot-upgradable transmission module, and set a callback function for receiving a data stream in the hot-upgradable transmission module as invalid, to block the hot-upgradable transmission module from receiving the data stream.

According to one or more embodiments of the present disclosure, the data saving module is further configured to: obtain each data stream in a hot-upgradable transmission module; and add each data stream in the hot-upgradable transmission module to a wait-to-transmit queue, and save transmission state information corresponding to each data stream in the wait-to-transmit queue.

According to one or more embodiments of the present disclosure, the data saving module is configured to add each data stream in the hot-upgradable transmission module to the wait-to-transmit queue, and save the transmission state information corresponding to each data stream in the wait-to-transmit queue, and is specifically configured to: for each data stream, if a transmission direction of the data stream is from the kernel module to a data processing unit, determine whether a retransmitted data stream in a sending state exists in a data retransmission queue, where the data retransmission queue is used to maintain a data stream that is retransmitted from the kernel module to the processor; if yes, add the data stream to the data retransmission queue when transmission of the retransmitted data stream in the sending state ends, delete a retransmission timer corresponding to the data retransmission queue when the addition is completed, and save a transmission state of each data stream maintained in the data retransmission queue; or if no, determine whether an initial transmitted data stream in a sending state exists in a data transmission queue. If yes, add the data stream to the data transmission queue when transmission of the initial transmitted data stream in the sending state ends, and save a transmission state of each data stream maintained in the data transmission queue when the addition is completed.

According to one or more embodiments of the present disclosure, the data saving module is configured to add each data stream in the hot-upgradable transmission module to the wait-to-transmit queue, and save the transmission state information corresponding to each data stream in the wait-to-transmit queue, and is specifically configured to: for each data stream, if a transmission direction of the data stream is from a data processing unit to the kernel module, determine a data type of the data stream; if the data type is control data, add the data stream to a data control queue, and save a transmission state of each data stream maintained in the data control queue when the addition is completed; or if the data type is non-control data, add the data stream to a data interface queue, and save a transmission state of each data stream maintained in the data interface queue when the addition is completed.

According to one or more embodiments of the present disclosure, the apparatus further includes a registration module. The registration module is configured to: register, in the new hot-upgradable transmission module, a callback function for receiving a data stream, and restore a resource allocation state of a reception data stream; and release the third read-write lock, and continue to transmit each data stream based on the transmission state information corresponding to each data stream in the wait-to-transmit queue.

In a third aspect, according to one or more embodiments of the present disclosure, there is provided an electronic device, including: a processor, and a memory in communication connection with the processor;
where the memory stores a computer-executable instruction; and
the processor executes the computer-executable instruction stored in the memory, to implement the hot upgrade method for the kernel module according to the first aspect and the various possible designs of the first aspect described above.

In a fourth aspect, according to one or more embodiments of the present disclosure, there is provided a computer-readable storage medium having a computer-executable instruction stored therein, and when a processor executes the computer-executable instruction, the hot upgrade method for the kernel module according to the first aspect and the various possible designs of the first aspect described above is implemented.

In a fifth aspect, an embodiment of the present disclosure provides a computer program product, including a computer program that, when executed by a processor, implements the hot upgrade method for the kernel module according to the first aspect and the various possible designs of the first aspect described above.

The foregoing descriptions are merely preferred embodiments of the present disclosure and explanations of the applied technical principles. A person skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure, for example, a technical solution formed by replacing the foregoing features with technical features having similar functions disclosed in the present disclosure (but not limited thereto).

In addition, although the various operations are depicted in a specific order, it should not be understood as requiring these operations to be performed in the specific order shown or in a sequential order. Under specific circumstances, multitasking and parallel processing may be advantageous. Similarly, although several specific implementation details are contained in the foregoing discussions, these details should not be construed as limiting the scope of the present disclosure. Some features that are described in the context of separate embodiments can also be implemented in combination in a single embodiment. In contrast, various features described in the context of a single embodiment can also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

What is claimed is:

1. A hot upgrade method for a kernel module, comprising:
when a hot upgrade request for the kernel module is triggered, calling a hot upgrade thread in a newly inserted hot upgrade updating module, and obtaining, by using the hot upgrade thread, a read-write lock that is pre-inserted into a basic module in the kernel module, to block first interface address information of a hot-upgradable module in the kernel module from being called, wherein the hot upgrade updating module comprises second interface address information corresponding to each of a plurality of function call interfaces; and wherein the kernel module comprises the basic module and the hot-upgradable module, the hot-upgradable module is a part in the kernel module that supports a hot upgrade operation, and the basic module is configured to support hot upgrade of the hot-upgradable module; and
calling each function to be hot-upgraded by using the hot upgrade thread, and replacing, for a function call interface corresponding to each function, the first interface address information corresponding to the function call interface with the second interface address information by using the hot upgrade thread, to complete hot upgrade for the kernel module.

2. The method according to claim 1, wherein the kernel module comprises an interface registration module; and
correspondingly, the obtaining, by using the hot upgrade thread, the read-write lock that is pre-inserted into the basic module in the kernel module, to block the first interface address information of the hot-upgradable module in the kernel module from being called comprises:
obtaining, by using the hot upgrade thread, a first read-write lock that is pre-inserted into a non-hot-upgradable registration module in the basic module, and blocking an application from calling a function call interface in the non-hot-upgradable registration module, to block first interface address information in a hot-upgradable registration module from being called.

3. The method according to claim 2, wherein the read-write lock further comprises a second read-write lock, and the second read-write lock is used to call a thread blocked in the hot-upgradable registration module; and
correspondingly, before the calling each function to be hot-upgraded by using the hot upgrade thread, and the replacing, for the function call interface corresponding to each function, the first interface address information corresponding to the function call interface with the second interface address information by using the hot upgrade thread, to complete the hot upgrade for the kernel module, the method further comprises:
waking up each data processing thread blocked in the hot-upgradable registration module, and determining whether each data processing thread is woken up by the hot upgrade thread; and if the data processing thread is woken up by the hot upgrade thread, setting the data processing thread to be in a hot upgrade state;
releasing, by each data processing thread in the hot-upgradable registration module, the second read-write lock that is pre-inserted into the non-hot-upgradable registration module in the basic module, and determining, in response to the hot upgrade thread obtaining the second read-write lock, that each data processing thread in the hot-upgradable registration module has exited the hot-upgradable registration module; and
saving state information corresponding to each data processing thread in the hot-upgradable registration module, and adding each data processing thread in the hot-upgradable registration module to a wait-to-execute queue.

4. The method according to claim 3, wherein the hot upgrade updating module comprises a new hot-upgradable registration module; and after the calling each function to be hot-upgraded by using the hot upgrade thread, and the replacing, for the function call interface corresponding to each function, the first interface address information corresponding to the function call interface with the second interface address information by using the hot upgrade thread, to complete the hot upgrade for the kernel module, the method further comprises:
waking up each data processing thread in the wait-to-execute queue, and setting each data processing thread from the hot upgrade state to a normal state;
releasing the first read-write lock and the second read-write lock; and
executing, for each data processing thread by using the new hot-upgradable registration module, the data processing thread based on the state information corresponding to the data processing thread.

5. The method according to claim 2, wherein the kernel module further comprises a data transmission module, and the data transmission module is configured to transmit a data stream sent by the interface registration module; and
correspondingly, the obtaining, by using the hot upgrade thread, the read-write lock that is pre-inserted into the basic module in the kernel module, to block the first interface address information of the hot-upgradable module in the kernel module from being called comprises:
obtaining, by using the hot upgrade thread, a third read-write lock that is pre-inserted into a non-hot-upgradable transmission module in the basic module, and blocking the interface registration module from calling a function call interface in the non-hot-upgradable transmission module, to block first interface address information in a hot-upgradable transmission module from being called; and
calling a pause function in the hot-upgradable transmission module, and setting a callback function for receiving a data stream in the hot-upgradable transmission module as invalid, to block the hot-upgradable transmission module from receiving the data stream.

6. The method according to claim 5, wherein before the calling each function to be hot-upgraded by using the hot upgrade thread, and the replacing, for the function call interface corresponding to each function, the first interface address information corresponding to the function call interface with the second interface address information by using the hot upgrade thread, to complete the hot upgrade for the kernel module, the method further comprises:
obtaining each data stream in the hot-upgradable transmission module; and
adding each data stream in the hot-upgradable transmission module to a wait-to-transmit queue, and saving transmission state information corresponding to each data stream in the wait-to-transmit queue.

7. The method according to claim 6, wherein the adding each data stream in the hot-upgradable transmission module to the wait-to-transmit queue, and the saving the transmission state information corresponding to each data stream in the wait-to-transmit queue comprise:
for each data stream, if a transmission direction of the data stream is from the kernel module to a data processing unit, determining whether a retransmitted data stream in a sending state exists in a data retransmission queue, wherein the data retransmission queue is configured to maintain a data stream that is retransmitted from the kernel module to the processor;
if the retransmitted data stream in the sending state exists, adding the data stream to the data retransmission queue when transmission of the retransmitted data stream in the sending state ends, deleting a retransmission timer corresponding to the data retransmission queue when the addition is completed, and saving a transmission state of each data stream maintained in the data retransmission queue; or
if no retransmitted data stream in the sending state exists, determining whether an initial transmitted data stream in a sending state exists in a data sending queue, and if the initial transmitted data stream in the sending state exists, adding the data stream to the data sending queue when transmission of the initial transmitted data stream in the sending state ends, and saving a transmission state of each data stream maintained in the data sending queue when the addition is completed.

8. The method according to claim 6, wherein the adding each data stream in the hot-upgradable transmission module to the wait-to-transmit queue, and the saving the transmission state information corresponding to each data stream in the wait-to-transmit queue comprise:
for each data stream, if a transmission direction of the data stream is from the data processing unit to the kernel module, determining a data type of the data stream;
if the data type is control data, adding the data stream to a data control queue, and saving a transmission state of each data stream maintained in the data control queue when the addition is completed; or
if the data type is non-control data, adding the data stream to a data interface queue, and saving a transmission state of each data stream maintained in the data interface queue when the addition is completed.

9. The method according to claim 6, wherein the hot upgrade updating module comprises a new hot-upgradable transmission module; and after the calling each function to be hot-upgraded by using the hot upgrade thread, and the replacing, for the function call interface corresponding to each function, the first interface address information corresponding to the function call interface with the second interface address information by using the hot upgrade thread, to complete the hot upgrade for the kernel module, the method further comprises:
registering, in the new hot-upgradable transmission module, a callback function for receiving a data stream, and restoring a resource allocation state of a reception data stream; and
releasing the third read-write lock, and continuing to transmit each data stream based on the transmission state information corresponding to each data stream in the wait-to-transmit queue.

10. An electronic device, comprising: a processor, and a memory that is communicatively connected to the processor,
wherein the memory stores a computer-executable instruction; and
the processor is configured to execute the computer-executable instruction stored in the memory to:
when a hot upgrade request for a kernel module is triggered, call a hot upgrade thread in a newly inserted hot upgrade updating module, and obtain, by using the hot upgrade thread, a read-write lock that is pre-inserted into a basic module in the kernel module, to block first interface address information of a hot-upgradable module in the kernel module from being called, wherein the hot upgrade updating module comprises second interface address information corresponding to each of a plurality of function call interfaces; and wherein the kernel module comprises the basic module and the hot-upgradable module, the hot-upgradable module is a part in the kernel module that supports a hot upgrade operation, and the basic module is configured to support hot upgrade of the hot-upgradable module; and
call each function to be hot-upgraded by using the hot upgrade thread, and replace, for a function call interface corresponding to each function, the first interface address information corresponding to the function call interface with the second interface address information by using the hot upgrade thread, to complete hot upgrade for the kernel module.

11. The electronic device according to claim 10, wherein the kernel module comprises an interface registration module; and the processor is configured to:
obtain, by using the hot upgrade thread, a first read-write lock that is pre-inserted into a non-hot-upgradable registration module in the basic module, and block an application from calling a function call interface in the non-hot-upgradable registration module, to block first interface address information in a hot-upgradable registration module from being called.

12. The electronic device according to claim 11, wherein the read-write lock further comprises a second read-write lock, and the second read-write lock is used to call a thread blocked in the hot-upgradable registration module; and the processor is configured to,
before calling each function to be hot-upgraded by using the hot upgrade thread, and replacing, for the function call interface corresponding to each function, the first interface address information corresponding to the function call interface with the second interface address information by using the hot upgrade thread, to complete the hot upgrade for the kernel module,
wake up each data processing thread blocked in the hot-upgradable registration module, and determine whether each data processing thread is woken up by the hot upgrade thread; and if the data processing thread is woken up by the hot upgrade thread, set the data processing thread to be in a hot upgrade state;
release, by each data processing thread in the hot-upgradable registration module, the second read-write lock that is pre-inserted into the non-hot-upgradable registration module in the basic module, and determine, in response to the hot upgrade thread obtaining the second read-write lock, that each data processing thread in the hot-upgradable registration module has exited the hot-upgradable registration module; and
save state information corresponding to each data processing thread in the hot-upgradable registration module, and add each data processing thread in the hot-upgradable registration module to a wait-to-execute queue.

13. The electronic device according to claim 12, wherein the hot upgrade updating module comprises a new hot-upgradable registration module; and the processor is configured to,
after calling each function to be hot-upgraded by using the hot upgrade thread, and replacing, for the function call interface corresponding to each function, the first interface address information corresponding to the function call interface with the second interface address information by using the hot upgrade thread, to complete the hot upgrade for the kernel module,
wake up each data processing thread in the wait-to-execute queue, and set each data processing thread from the hot upgrade state to a normal state;
release the first read-write lock and the second read-write lock; and
execute, for each data processing thread by using the new hot-upgradable registration module, the data processing thread based on the state information corresponding to the data processing thread.

14. The electronic device according to claim 11, wherein the kernel module further comprises a data transmission module, and the data transmission module is configured to transmit a data stream sent by the interface registration module; and the processor is configured to:
obtain, by using the hot upgrade thread, a third read-write lock that is pre-inserted into a non-hot-upgradable transmission module in the basic module, and block the interface registration module from calling a function call interface in the non-hot-upgradable transmission module, to block first interface address information in a hot-upgradable transmission module from being called; and
call a pause function in the hot-upgradable transmission module, and set a callback function for receiving a data stream in the hot-upgradable transmission module as invalid, to block the hot-upgradable transmission module from receiving the data stream.

15. The electronic device according to claim 14, wherein the processor is configured to,
before calling each function to be hot-upgraded by using the hot upgrade thread, and replacing, for the function call interface corresponding to each function, the first interface address information corresponding to the function call interface with the second interface address information by using the hot upgrade thread, to complete the hot upgrade for the kernel module,
obtain each data stream in the hot-upgradable transmission module; and
add each data stream in the hot-upgradable transmission module to a wait-to-transmit queue, and save transmission state information corresponding to each data stream in the wait-to-transmit queue.

16. The electronic device according to claim 15, wherein the processor is configured to:
for each data stream, if a transmission direction of the data stream is from the kernel module to a data processing unit, determine whether a retransmitted data stream in a sending state exists in a data retransmission queue, wherein the data retransmission queue is configured to maintain a data stream that is retransmitted from the kernel module to the processor;
if the retransmitted data stream in the sending state exists, add the data stream to the data retransmission queue when transmission of the retransmitted data stream in the sending state ends, delete a retransmission timer corresponding to the data retransmission queue when the addition is completed, and save a transmission state of each data stream maintained in the data retransmission queue; or
if no retransmitted data stream in the sending state exists, determine whether an initial transmitted data stream in a sending state exists in a data sending queue, and if the initial transmitted data stream in the sending state exists, add the data stream to the data sending queue when transmission of the initial transmitted data stream in the sending state ends, and save a transmission state of each data stream maintained in the data sending queue when the addition is completed.

17. The electronic device according to claim 15, wherein the processor is configured to:
for each data stream, if a transmission direction of the data stream is from the data processing unit to the kernel module, determine a data type of the data stream;
if the data type is control data, add the data stream to a data control queue, and save a transmission state of each data stream maintained in the data control queue when the addition is completed; or
if the data type is non-control data, add the data stream to a data interface queue, and save a transmission state of each data stream maintained in the data interface queue when the addition is completed.

18. The electronic device according to claim 15, wherein the hot upgrade updating module comprises a new hot-upgradable transmission module; and the processor is configured to,
after calling each function to be hot-upgraded by using the hot upgrade thread, and replacing, for the function call interface corresponding to each function, the first interface address information corresponding to the function call interface with the second interface address information by using the hot upgrade thread, to complete the hot upgrade for the kernel module,
register, in the new hot-upgradable transmission module, a callback function for receiving a data stream, and restore a resource allocation state of a reception data stream; and
release the third read-write lock, and continue to transmit each data stream based on the transmission state information corresponding to each data stream in the wait-to-transmit queue.

19. A non-transitory computer-readable storage medium in which a computer-executable instruction is stored, wherein when a processor executes the computer-executable instruction, the following steps are performed:
when a hot upgrade request for a kernel module is triggered, calling a hot upgrade thread in a newly inserted hot upgrade updating module, and obtaining, by using the hot upgrade thread, a read-write lock that is pre-inserted into a basic module in the kernel module, to block first interface address information of a hot-upgradable module in the kernel module from being called, wherein the hot upgrade updating module comprises second interface address information corresponding to each of a plurality of function call interfaces; and wherein the kernel module comprises the basic module and the hot-upgradable module, the hot-upgradable module is a part in the kernel module that supports a hot upgrade operation, and the basic module is configured to support hot upgrade of the hot-upgradable module; and
calling each function to be hot-upgraded by using the hot upgrade thread, and replacing, for a function call interface corresponding to each function, the first interface address information corresponding to the function call interface with the second interface address information by using the hot upgrade thread, to complete hot upgrade for the kernel module.

20. The non-transitory computer-readable storage medium according to claim 19, wherein the kernel module comprises an interface registration module; and
the obtaining, by using the hot upgrade thread, the read-write lock that is pre-inserted into the basic module in the kernel module, to block the first interface address information of the hot-upgradable module in the kernel module from being called comprises:
obtaining, by using the hot upgrade thread, a first read-write lock that is pre-inserted into a non-hot-upgradable registration module in the basic module, and blocking an application from calling a function call interface in the non-hot-upgradable registration module, to block first interface address information in a hot-upgradable registration module from being called.
